(19) United States
(12) Patent Application Publication
(10) Pub. No.: US 2026/0118129 A1
(43) Pub. Date: Apr. 30, 2026

(54) USING TRANSFORMERS TO GENERATE MAPS FOR USE BY AUTONOMOUS VEHICLES

(71) Applicant: Waymo LLC, Mountain View, CA (US)

(72) Inventors: Congrui Hetang, Mountain View, CA (US); Guan Sun, Sunnyvale, CA (US); Yan Jiao, Mountain View, CA (US); Xiaohan Jin, Sunnyvale, CA (US); Yue Shen, Newark, CA (US); Ningshan Zhang, San Francisco, CA (US); Guohao Zhang, Sunnyvale, CA (US)

(21) Appl. No.: 18/934,111

(22) Filed: Oct. 31, 2024

(51) Int. Cl. G01C 21/30; G01C 21/00

(52) U.S. Cl. CPC G01C 21/30; G01C 21/3804

(57) ABSTRACT

The described aspects and implementations include a method for using transformers to generate maps for use by AVs. The method includes generating an input embedding based, at least in part, on sensing data from a sensing system of the AV; selecting one or more transformer decoder queries directing a transformer decoder to a particular portion of the input embedding; generating, using the one or more transformer decoder queries and the input embedding as input to the transformer decoder, one or more driving environment embeddings for a navigation system of the AV, and each driving environment embedding comprises a vector representation of a feature of the driving environment; providing the one or more driving environment embeddings to the navigation system of the AV, wherein the navigation system is configured to navigate the AV in the driving environment based, at least in part, on the one or more driving environment embeddings.

### TECHNICAL FIELD

The instant specification generally relates to autonomous vehicles (AVs). More specifically, the instant specification relates to using transformers to generate maps for use by AVs.

### BACKGROUND

Autonomous vehicles (AVs), whether fully autonomous or partially self-driving, often operate by sensing an outside environment with various sensors (e.g., radar, optical, audio, humidity, etc.). This outside environment may include other objects in the environment, some of which are mobile. Such objects can include other vehicles, cyclists, pedestrians, animals, etc. AVs may also use a map to navigate the outside environment.

### BRIEF DESCRIPTION OF THE DRAWINGS

The present disclosure is illustrated by way of examples, and not by way of limitation, and can be more fully understood with references to the following detailed description when considered in connection with the figures, in which:

FIG. 1 depicts a block diagram of an example autonomous vehicle (AV), in accordance with some implementations of the present disclosure.

FIG. 2 depicts a block diagram of an example artificial intelligence (AI) training subsystem, in accordance with some implementations of the present disclosure.

FIG. 3 depicts a block diagram of an example AI inference subsystem, in accordance with some implementations of the present disclosure.

FIG. 4A depicts a block diagram of an example data flow for using transformers to generate maps for use by AVs, in accordance with some implementations of the present disclosure.

FIG. 4B depicts a block diagram continuing the example data flow for using transformers to generate maps for use by AVs of FIG. 4A, in accordance with some implementations of the present disclosure.

FIG. 5 depicts a flow diagram for using transformers to generate maps for use by AVs, in accordance with some implementations of the present disclosure.

FIG. 6 depicts a top-down view of a driving environment, in accordance with some implementations of the present disclosure.

FIG. 7 depicts a schematic diagram of a representation of the driving environment of FIG. 6, in accordance with some implementations of the present disclosure.

FIG. 8 depicts a block diagram of an example computer device capable of using transformers to generate maps for use by AVs, in accordance with some implementations of the present disclosure.

### SUMMARY

In one implementation, disclosed is a method for using transformers to generate maps for use by autonomous vehicles (AVs). The method includes generating, using a mapping subsystem of an AV, an input embedding based, at least in part, on sensing data from a sensing system of the AV. The input embedding may define a driving environment of the AV. The method includes selecting, using the mapping subsystem, one or more transformer decoder queries directing a transformer decoder to a particular portion of the input embedding. The method includes generating, using the one or more transformer decoder queries and the input embedding as input to the transformer decoder, one or more driving environment embeddings for a navigation system of the AV. Each driving environment embedding may include a vector representation of a feature of the driving environment. The method includes providing the one or more driving environment embeddings to the navigation system of the AV. The navigation system can be configured to navigate the AV in the driving environment based, at least in part, on the one or more driving environment embeddings.

In one implementation, disclosed is a system for using transformers to generate maps for use by AVs. The system includes a mapping subsystem of an AV. The mapping subsystem can be configured to generate an input embedding based, at least in part, on sensing data from a sensing system of the AV. The input embedding may define a driving environment of the AV. The mapping subsystem can be configured to select one or more transformer decoder queries directing a transformer decoder to a particular portion of the input embedding. The mapping subsystem can be configured to generate, using the one or more transformer decoder queries and the input embedding as input to the transformer decoder, one or more driving environment embeddings for a navigation system of the AV. Each driving environment embedding may include a vector representation of a feature of the driving environment. The mapping subsystem can be configured to provide the one or more driving environment embeddings to the navigation system of the AV. The navigation system may be configured to navigate the AV in the driving environment based, at least in part, on the one or more driving environment embeddings.

In one implementation, disclosed is another method for using transformers to generate maps for use by AVs. The method includes generating, using a mapping subsystem of an AV, an input embedding based, at least in part, on sensing data from a sensing system of the AV. The input embedding can define a driving environment of the AV. The method includes selecting, using the mapping subsystem, one or more transformer decoder queries directing a transformer decoder to a particular portion of the input embedding. The method includes generating, using the one or more transformer decoder queries and the input embedding as input to the transformer decoder, one or more driving environment embeddings. Each driving environment embedding may include a vector representation of a feature of the driving environment. The method includes generating, using a first artificial intelligence (AI) model and using a first driving environment embedding of the one or more driving environment embeddings, a boundary output. The boundary output may include data indicating a feature of a boundary of the driving environment. The method includes providing the boundary output to a navigation system of the AV. The navigation system can be configured to navigate the AV in the driving environment based, at least in part, on the boundary output.

### DETAILED DESCRIPTION

An autonomous vehicle or a vehicle deploying various driving assistance features (AV) often uses a map to navigate through a driving environment. The map may include data indicating road information and other information about a driving environment. For example, the map may include data indicating one or more roads, and for each road the map may include data indicating one or more lanes of the road. The data indicating a lane may indicate data about aspects of the lane (e.g., a direction of travel, a speed limit of the lane, whether the lane is controlled by a traffic light or other traffic feature, etc.). The map may include data indicating other aspects of the driving environment.

The map may be stored on the AV or stored on a server in data communication with the AV. However, the map may include a map generated before the time in which the AV is currently driving in the driving environment and, thus, the map may be out of date by the time the AV uses the map. For example, a lane of a road may be closed for construction, a new lane may have been added to a road, or an entirely new road may have been built. Some AVs may include a mapping system that can update a map using data from the AVs sensors, however, the data usually consists of raw sensor data (or lightly processed sensor data) representing the area around the AV, which has limited information usable by the mapping system.

Aspects and implementations of the present disclosure address these and other challenges of existing AV systems. The present disclosure provides a system for using transformers to generate maps for use by AVs. The system can use dense representations of a driving environment (e.g., heatmaps based on sensor data of the environment, data representing mobile or static objects in the driving environment, data indicating a region of interest in the driving environment, and/or road lane connectivity graphs) to generate image embeddings or tokens. The system uses the image embeddings and tokens as input to a transformer encoder to generate input embeddings. The image embeddings and tokens may include data that represent a driving environment of an AV. The system uses the input embeddings, along with transformer queries, as input to a transformer decoder, and the transformer decoder generates boundary embeddings that represent boundaries in the driving environment and lane embeddings that represent lanes in the driving environment. The boundary embeddings and lane embeddings have more information (e.g., polylines that represent a boundary or lane, data indicating the type of boundary or lane marker, etc.) than conventional boundary and lane data used by conventional AVs, which may include prediction heatmaps of the driving environment. The system can provide the boundary embeddings and lane embeddings to a mapping system of the AV to generate or update a map of the AV's driving environment. The mapping system can provide the lane embeddings and boundary embeddings to a navigation system of the AV to navigate in the driving environment.

The advantages of the disclosed techniques and systems include, but are not limited to, more detailed and accurate maps of AV driving environments. By using embeddings based on dense representations of the driving environment as input to transformer encoders and decoders to generate embeddings that represent lanes and boundaries of a driving environment, the systems and methods of the present disclosure provide richer data about the driving environment, which can be used to update or generate maps used by AVs and can be used to better navigate AVs in the driving environment. The data about the driving environment generated by the transformer architecture provides more details about the driving environment than generic machine learning models that use raw sensor data as input. Furthermore, since the systems and methods use image embeddings, tokens, and other data that represent a driving environment, the systems and methods can use similar image embeddings, tokens, and other data for simulated driving environments in order to train the transformer components and other artificial intelligence (AI) components used by the AV, which can result in more accurate transformer and AI components that produce more accurate outputs. As a result, lanes and boundaries, including lanes blocked by construction zones and boundaries delineated by static objects (e.g., construction cones or barriers) are more accurate.

In those instances where the description of implementations refers to AVs, it should be understood that similar techniques can be used in various driver assistance systems that do not rise to the level of fully autonomous driving systems. More specifically, disclosed techniques can be used in Society of Automotive Engineers (SAE) Level 2 driver assistance systems that implement steering, braking, acceleration, lane centering, adaptive cruise control, etc., as well as other driver support. Likewise, the disclosed techniques can be used in SAE Level 3 driving assistance systems capable of autonomous driving under limited (e.g., highway) conditions. In such systems, fast and accurate detection and tracking of mobile objects can be used to inform the driver of the approaching objects, with the driver making the ultimate driving decisions (e.g., in SAE Level 2 systems), or to make certain driving decisions (e.g., in SAE Level 3 systems), such as reducing speed, changing lanes, etc., without requesting driver's feedback.

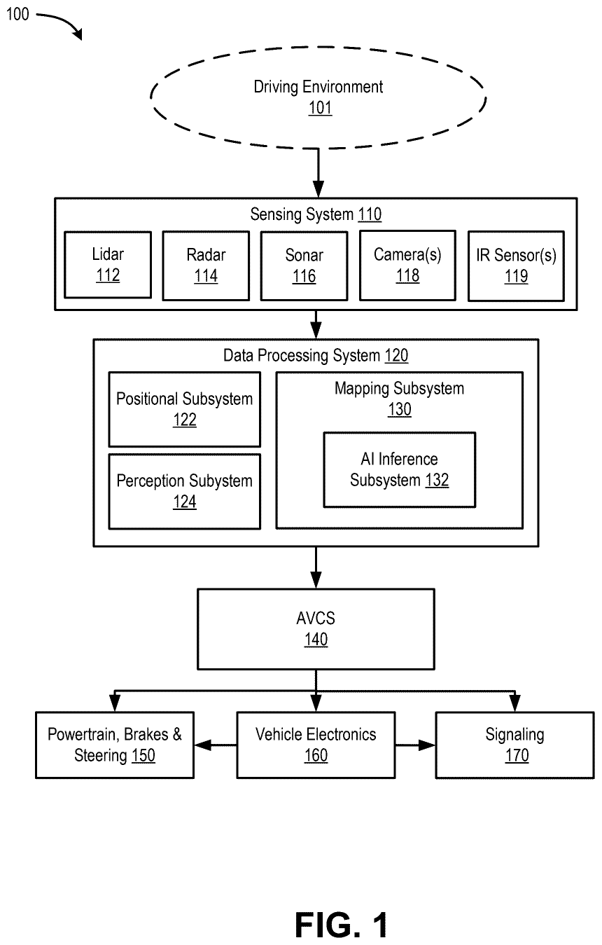

FIG. 1 is a diagram illustrating components of an example AV 100 capable of using transformers to generate maps for use by AVs, in accordance with some implementations of the present disclosure. AVs 100 can include motor vehicles (cars, trucks, buses, motorcycles, all-terrain vehicles, recreational vehicles, any specialized farming or construction vehicles, and the like), aircraft (planes, helicopters, drones, and the like), naval vehicles (ships, boats, yachts, submarines, and the like), or any other self-propelled vehicles (e.g., robots, factory or warehouse robotic vehicles, sidewalk delivery robotic vehicles, etc.) capable of being operated in a self-driving mode (without a human input or with a reduced human input).

An environment 101 around the AV 100 (sometimes referred to as the “driving environment”) can include any objects (animated or non-animated) located outside the AV 100, such as roadways, buildings, trees, bushes, sidewalks, bridges, mountains, other vehicles, pedestrians, animals, and so on. The driving environment 101 can be urban, suburban, rural, and so on. In some implementations, the driving environment 101 can be an off-road environment (e.g., farming or other agricultural land). In some implementations, the driving environment can be an indoor environment, (e.g., the environment of an industrial plant, a shipping warehouse, a hazardous area of a building, and so on). In some implementations, the driving environment 101 can be substantially flat, with various objects moving parallel to a surface (e.g., parallel to the surface of the Earth). In other implementations, the driving environment 101 can be three-dimensional and can include objects that are capable of moving along all three directions (e.g., balloons, leaves, etc.). Hereinafter, the term “driving environment” should be understood to include all environments in which an autonomous motion of self-propelled vehicles can occur. For example, the “driving environment” can include any possible flying environment of an aircraft or a marine environment of a naval vessel. The objects of the driving environment 101 can be located at any distance from the AV 100, from close distances of several feet (or less) to several miles (or more).

As described herein, in a semi-autonomous or partially autonomous driving mode, even though the AV 100 assists with one or more driving operations (e.g., steering, braking and/or accelerating to perform lane centering, adaptive cruise control, advanced driver assistance systems (ADAS), or emergency braking), the human driver is expected to be situationally aware of the AV's 100 surroundings and supervise the assisted driving operations. Here, even though the AV 100 may perform all driving tasks in certain situations, the human driver is expected to be responsible for taking control as needed.

Although, for brevity and conciseness, various systems and methods may be described below in conjunction with AVs 100, similar techniques can be used in various driver assistance systems that do not rise to the level of fully autonomous driving systems. In the United States, the SAE have defined different levels of automated driving operations to indicate how much, or how little, a vehicle controls the driving, although different organizations, in the United States or in other countries, may categorize the levels differently. More specifically, disclosed systems and methods can be used in SAE Level 2 (L2) driver assistance systems that implement steering, braking, acceleration, lane centering, adaptive cruise control, etc., as well as other driver support. The disclosed systems and methods can be used in SAE Level 3 (L3) driving assistance systems capable of autonomous driving under limited (e.g., highway) conditions. Likewise, the disclosed systems and methods can be used in vehicles that use SAE Level 4 (L4) self-driving systems that operate autonomously under most regular driving situations and require only occasional attention of the human operator. In all such driving assistance systems, accurate lane estimation can be performed automatically without a driver input or control (e.g., while the vehicle is in motion) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

The example AV 100 can include a sensing system 110. The sensing system 110 can include various electromagnetic (e.g., optical) and non-electromagnetic (e.g., acoustic) sensing subsystems and/or devices. The sensing system 110 can include a radar 114 (or multiple radars 114), which can be any system that utilizes radio or microwave frequency signals to sense objects within the driving environment 101 of the AV 100. The radar(s) 114 can be configured to sense both the spatial locations of the objects (including their spatial dimensions) and velocities of the objects (e.g., using Doppler shift technology). Hereinafter, “velocity” refers to both how fast the object is moving (the speed of the object) as well as the direction of the object's motion. The sensing system 110 can include a lidar 112, which can be a laser-based unit capable of determining distances to the objects and velocities of the objects in the driving environment 101. Each of the lidar 112 and radar 114 can include a coherent sensor, such as a frequency-modulated continuous-wave (FMCW) lidar or radar sensor. For example, radar 114 can use heterodyne detection for velocity determination. In some implementations, the functionality of a ToF and coherent radar is combined into a radar unit capable of simultaneously determining both the distance to and the radial velocity of the reflecting object. Such a unit can be configured to operate in an incoherent sensing mode (ToF mode) and/or a coherent sensing mode (e.g., a mode that uses heterodyne detection) or both modes at the same time. In some implementations, multiple lidars 112 or radars 114 can be mounted on the AV 100.

Lidar 112 can include one or more light sources producing and emitting signals and one or more detectors of the signals reflected back from the objects. In some implementations, lidar 112 can perform a 360-degree scan in a horizontal direction. In some implementations, lidar 112 can be capable of spatial scanning along both the horizontal and vertical directions. In some implementations, the field of view can be up to 90 degrees in the vertical direction (e.g., with at least a part of the region above the horizon being scanned with radar signals). In some implementations, the field of view can be a full sphere (consisting of two hemispheres).

The sensing system 110 can further include one or more cameras 118 configured to capture images of the driving environment 101. The images can be two-dimensional projections of the driving environment 101 (or parts of the driving environment 101) onto a projecting surface (flat or non-flat) of the camera(s). Some of the cameras 118 of the sensing system 110 can be video cameras configured to capture a continuous (or quasi-continuous) stream of images of the driving environment 101. The sensing system 110 can also include one or more infrared (IR) sensors 119. The sensing system 110 can further include one or more sonars 116, which can be ultrasonic sonars, in some implementations.

The AV 100 can include a data processing system 120. The data processing system 120 may include one or more computers or computing devices. The data processing system 120 may include hardware or software that receives data from the sensing system 110, processes the received data, and determines how the AV 100 should operate in the driving environment 101. In some implementations, the data processing system 120 can receive non-electromagnetic data, such as audio data (e.g., ultrasonic sensor data, or data from a microphone picking up emergency vehicle sirens), temperature sensor data, humidity sensor data, pressure sensor data, meteorological data (e.g., wind speed and direction, precipitation data), and the like.

The data processing system 120 can include a positioning subsystem 122, a perception subsystem 124, and/or a mapping subsystem 130. The positioning subsystem 122 uses positioning data (e.g., global positioning system (GPS) data, inertial measurement unit (IMU) data, or other positioning data) to help accurately determine the location of the AV 100. The perception subsystem 124 may be configured to process data received from the sensing system 110 to generate data representations of the driving environment 101. The data representations of the driving environment 101 may then be used by other subsystems of the data processing system 120, such as the mapping subsystem 130, to perform various operations such as generating a map of the driving environment 101.

The mapping subsystem 130 may store or have data access to a map of the driving environment 101. The mapping subsystem 130 may obtain one or more representations of the driving environment 101 from the perception subsystem 124 and generate or update a map of the driving environment 101. The mapping subsystem 130 may be configured to generate an output usable by the AV control system (AVCS) 140. The mapping subsystem 130 may include an AI inference subsystem 132. The AI inference subsystem 132 may include one or more AI models that can be used to generate or update a map of the driving environment 101, as discussed below.

The data processed or generated by the data processing system 120, including the perception subsystem 124 and the mapping subsystem 130, can be used by the AVCS 140 of the AV 100. The AVCS 140 can include one or more algorithms that plan how the AV 100 is to behave in various driving situations and environments. For example, the AVCS 140 can include a navigation system for determining a global driving route to a destination point. The AVCS 140 can also include a driving path selection system for selecting a particular path through the immediate driving environment 101, which can include selecting a traffic lane, negotiating traffic congestion, choosing a place to make a U-turn, selecting a trajectory for a parking maneuver, and so on. The AVCS 140 can also include an obstacle avoidance system for safe avoidance of various objects or other obstructions (rocks, stalled vehicles, a jaywalking pedestrian, and so on) within the driving environment 101 of the AV 100. The obstacle avoidance system can be configured to evaluate the size of the obstacles and the trajectories of the obstacles (if obstacles are animated) and select an optimal driving strategy (e.g., braking, steering, accelerating, etc.) for avoiding the obstacles.

In some embodiments, a navigation system of the AVCS 140 can control various systems and components of the AV 100. The navigation system can generate control outputs or signals or can trigger a communication received by various systems and components of the AV 100, such as the powertrain, brakes, and steering 150, vehicle electronics 160, signaling 170, and other systems and components not explicitly shown in FIG. 1. These systems and components may modify the operations of the AV 100 based on the control outputs, signals, or communications. The powertrain, brakes, and steering 150 can include an engine (internal combustion engine, electric engine, and so on), transmission, differentials, axles, wheels, steering mechanism, and other systems. The vehicle electronics 160 can include an on-board computer, engine management, ignition, communication systems, carputers, telematics, in-car entertainment systems, and other systems and components. The signaling 170 can include high and low headlights, stopping lights, turning and backing lights, horns and alarms, an inside lighting system, a dashboard notification system, a passenger notification system, radio and wireless network transmission systems, and so on. Some of the instructions output by the AVCS 140 can be delivered directly to the powertrain, brakes, and steering 150 (or signaling 170) whereas other instructions output by the AVCS 140 are first delivered to the vehicle electronics 160, which generates commands to the powertrain, brakes, and steering 150 and/or signaling 170.

In one example, the AVCS 140 can determine that an obstacle identified by the data processing system 120 is to be avoided by decelerating the vehicle until a safe speed is reached, followed by steering the vehicle around the obstacle. The AVCS 140 can output instructions to the powertrain, brakes, and steering 150 (directly or via the vehicle electronics 160) to: (1) reduce, by modifying the throttle settings, a flow of fuel to the engine to decrease the engine rpm; (2) downshift, via an automatic transmission, the drivetrain into a lower gear; (3) engage a brake unit to reduce (while acting in concert with the engine and the transmission) the vehicle's speed until a safe speed is reached; and (4) perform, using a power steering mechanism, a steering maneuver until the obstacle is safely bypassed. Subsequently, the AVCS 140 can output instructions to the powertrain, brakes, and steering 150 to resume the previous speed settings of the vehicle.

As used herein, the term “object” or “objects” can include any entity, item, device, body, or article (animate or inanimate) located outside the AV 100, such as other vehicles, cyclists, pedestrians, animals, roadways, buildings, trees, bushes, sidewalks, bridges, mountains, piers, banks, landing strips, or other things.

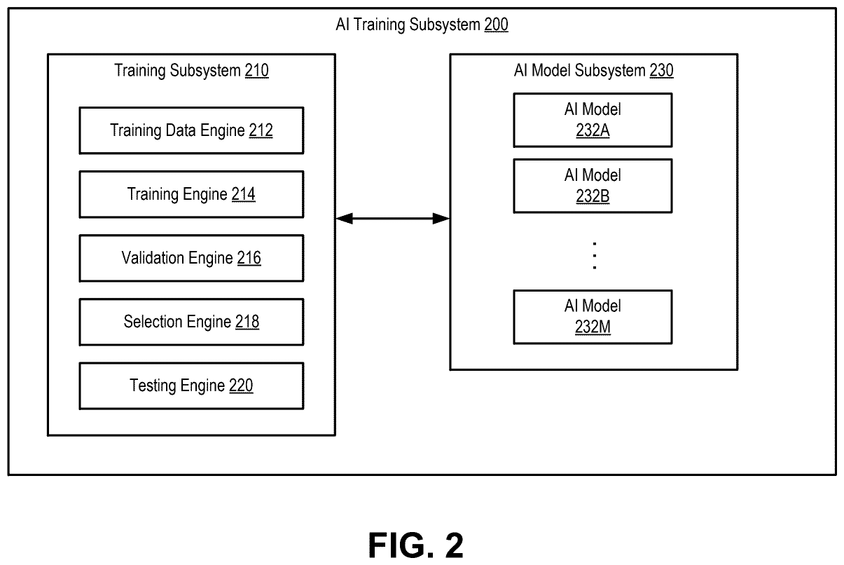

FIG. 2 illustrates an example AI training subsystem 200, in accordance with implementations of the present disclosure. As illustrated in FIG. 2, the AI training subsystem 200 may include a training subsystem 210, which may include a training data engine 212, a training engine 214, a validation engine 216, a selection engine 218, or a testing engine 220. The AI training subsystem 200 may include an AI model subsystem 230. The AI model subsystem 230 may include one or more AI models 232A-M.

In one implementation, the AI model 232A-M includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one implementation, an AI model 232A-M includes a transformer machine learning model (also referred to herein as a “transformer”). A transformer may be configured to process sequential data, such as a sequence of embeddings that represent sequential portions of a driving environment 101, by leveraging an attention mechanism, which allows the transformer to weigh the importance of different parts of the input sequence when generating output. A transformer may include an encoder that processes the input sequence, converting the input into a sequence of hidden representations. The representations can capture the semantic and syntactic information of the input. The transformer may include a decoder, which may generate the output sequence, using the encoder's hidden representations and attention mechanism to focus on relevant parts of the input.

In some implementations, an AI model 232A-M is an AI model that has been trained on a corpus of data. In some implementations, the AI model 232A-M can be a model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model 232A-M to learn broad elements including, image recognition, object identification, conversion of sensing system 110 data into embeddings that represent a driving environment 101, and other elements. In some implementations, this first, foundational model is trained using self-supervision, or unsupervised training on such datasets. In some implementations, the AI model 232A-M is then further trained or fine-tuned on organizational data, including proprietary organizational data.

In some implementations, the second portion of training, including fine-tuning, may be unsupervised, supervised, reinforced, or any other type of training. In some implementations, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 232A-M while training can be ranked by a user, according to a variety of factors, including accuracy, helpfulness, veracity, acceptability, or any other metric useful in the fine-tuning portion of training. In this manner, the AI model 232A-M can learn to favor these and any other factors relevant to users when generating a response. Further details regarding training are provided below.

In some implementations, an AI model 232A-M includes one or more pre-trained models, or fine-tuned models. In a non-limiting example, in some implementations, the goal of the “fine-tuning” is accomplished with a second, or third, or any number of additional models. For example, the outputs of the pre-trained model can be input into a second AI model 232A-M that has been trained in a similar manner as the “fine-tuned” portion of training above. In such a way, two more AI models 232A-M can accomplish work similar to one model that has been pre-trained, and then fine-tuned.

As indicated above, an AI model 232A-M may be one or more generative AI models 232A-M, allowing for the generation of new and original content. The generative AI model 232A-M can use other machine learning models including an encoder-decoder architecture including one or more self-attention mechanisms, and one or more feed-forward mechanisms. In some implementations, the generative AI model 232A-M includes an encoder that can encode input data into a vector space representation; and a decoder that can reconstruct the data from the vector space, generating outputs with increased novelty and uniqueness. The self-attention mechanism can compute the importance of certain portions of data with respect to all of the data. A generative AI model 232A-M can also utilize the previously discussed deep learning techniques, including RNNs, CNNs, or transformer networks. Further details regarding generative AI models 232A-M are provided herein.

In some implementations, different AI models 232A-M of the one or more AI models 232A-M are different types of AI models 232A-M. Multiple AI models 232A-M of the one or more AI models 232A-M can form an ensemble.

In one implementation, the training subsystem 210 manages the training and testing of the one or more AI models 232A-M. The training data engine 212 can generate training data (e.g., a set of training inputs and a set of target outputs) to train an AI model 232A-M. In an illustrative example, the training data engine 212 can initialize a training set T to null. The training data engine 212 can add the training data to the training set T and can determine whether training set T is sufficient for training the AI model 232A-M. The training set T can be sufficient for training the AI model 232A-M if the training set T includes a threshold amount of training data, in some implementations. In response to determining that the training set T is not sufficient for training, the training data engine 212 can identify additional training data and add it to the training set T. In response to determining that the training set T is sufficient for training, the training data engine 212 can provide the training set T to the training engine 214.

The training engine 214 can train the AI model 232A-M using the training data (e.g., training set T). The AI model 232A-M can refer to the model artifact that is created by the training engine 214 using the training data, where such training data can include training inputs and, in some implementations, corresponding target outputs (e.g., correct answers for respective training inputs). The training engine 214 can input the training data into the AI model 232A-M so that the AI model 232A-M can find patterns in the training data and configure itself based on those patterns.

Where the AI model 232A-M uses supervised learning, the training engine 214 can assist the AI model 232A-M in determining whether the AI model 232A-M maps the training input to the target output (the answer to be predicted). Where the AI model 232A-M uses unsupervised learning, the training engine 214 can input the training data into the AI model 232A-M. The AI model 232A-M can configure itself based on the input training data, but since the training data may not include a target output, the training engine 214 may not assist the AI model 232A-M in determining whether the AI model 232A-M provided a correct output during the training process.

The validation engine 216 may be capable of validating a trained AI model 232A-M using a corresponding set of features of a validation set from the training data engine 212. The validation engine 216 can determine an accuracy of each of the trained AI models 232A-M based on the corresponding sets of features of the validation set. Where the training data may not include a target output, validating a trained AI model 232A-M may include obtaining an output from the AI model 232A-M and providing the output to another entity for evaluation. The other entity may include another AI model configured to evaluate the output of the AI model that is undergoing training. The other entity may include a human. The validation engine 216 can discard a trained AI model 232A-M that has an accuracy that does not meet a threshold accuracy or that otherwise fails evaluation. In some implementations, the selection engine 218 is capable of selecting a trained AI model 232A-M that has an accuracy that meets a threshold accuracy. In some implementations, the selection engine 218 is capable of selecting the trained AI model 232A-M that has the highest accuracy of multiple trained AI models 232A-M. In some implementations, the selection engine 218 obtains input from another AI model or a human and can select a trained AI model 232A-M based on the input.

The testing engine 220 may be capable of testing a trained AI model 232A-M using a corresponding set of features of a testing set from the training data engine 212. For example, a first trained AI model 232A-M that was trained using a first set of features of the training set may be tested using the first set of features of the testing set. The testing engine 220 can determine a trained AI model 232A-M that has the highest accuracy or other evaluation of all of the trained AI models 232A-M based on the testing sets.

In some implementations, the AI model subsystem 230 selects an AI model 232A-M from the one or more AI models 232A-M. Selecting an AI model 232A-M may include selecting the AI model 232A-M for training or for use. For example, the training subsystem 210 can provide data to the AI model subsystem 230 indicating which AI model 232A-M is to be trained. The AI model subsystem 230 can obtain data from a component of the mapping subsystem 130 indicating which AI model 232A-M to use to generate an output.

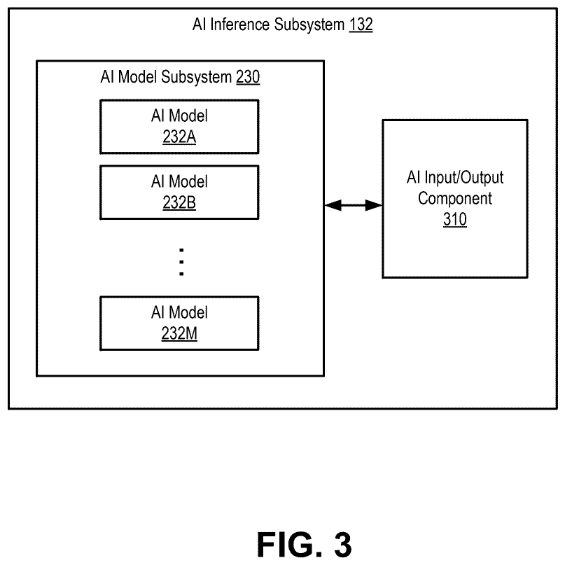

FIG. 3 depicts one implementation of an AI inference subsystem 132. The AI inference subsystem 132 may include the AI model subsystem 230, which may include one or more AI models 232A-M. The AI inference subsystem 132 may include an AI input/output component 310. The AI input/output component 310 may be configured to feed data as input to an AI model 232A-M and obtain one or more outputs. In such implementations, the AI input/output component 310 feeds embeddings or tokens as input to a transformer AI model 232A-M and obtains one or more output embeddings. The mapping subsystem 130 may use the output embeddings as input to other AI models 232A-M or other components of the mapping subsystem 130 to generate outputs that can be used to generate or update a map of the driving environment 101.

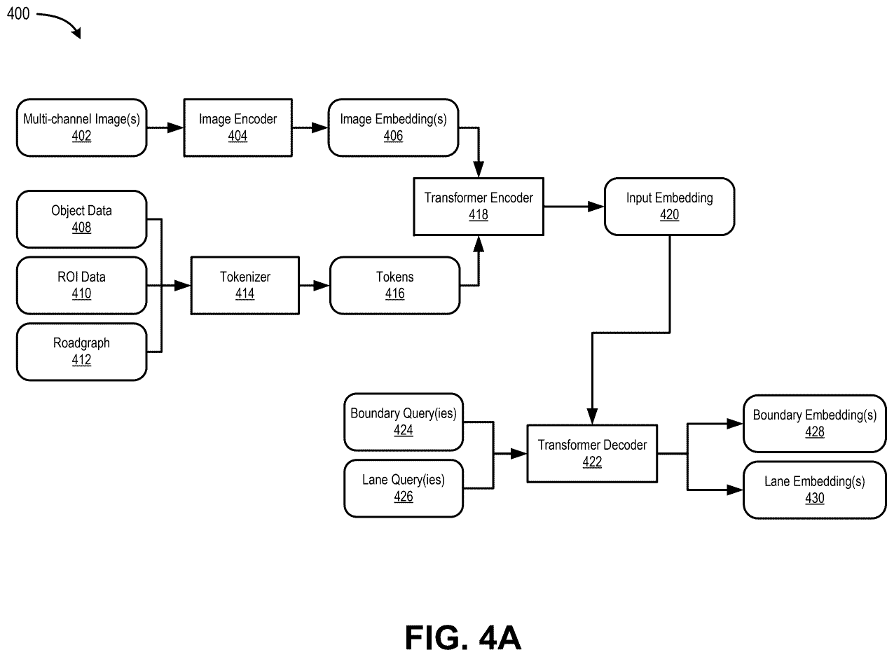

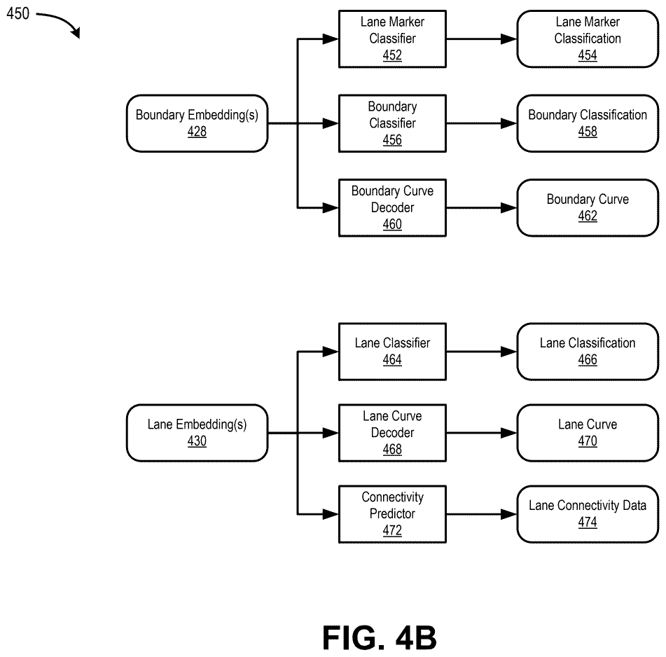

FIG. 4A depicts a block diagram of an example data flow 400 for using transformers to generate maps for use by AVs 100, in accordance with some implementations of the present disclosure. One or more portions of the data flow 400 may occur at the mapping subsystem 130 of the AV 100 of FIG. 1.

In one implementation, one or more multichannel images 402 may be provided to an image encoder 404. A multichannel image 402 may include a multichannel image, where each channel may represent different information about the driving environment 101. The multichannel image 402 may include a heatmap. The heatmap may indicate one or more locations in the driving environment 101 and, for each location of the one or more locations, a probability of the presence of an object or feature of the driving environment 101 at the respective location. Such objects or features may include a road or lane marker, a road edge, or other objects or features of the driving environment 101. In some implementations, a multichannel image 402 may include an image of a portion of the driving environment 101. In some implementations, the perception subsystem 124 may generate the one or more multichannel images 402 from sensor data of the sensing system 110.

In one implementation, the image encoder 404 may include software (or a portion thereof) configured to generate an image embedding 406 based on a multichannel image 402. An embedding can refer to any suitable digital representation of an input data, e.g., as a vector of any number of components, which can have integer values or floating-point values. Embeddings can be considered as vectors or points in an N-dimensional embedding space with the dimensionality N of the embedding space being smaller than the size of the input data. For example, an image embedding 406 may include a vector representation of a multichannel image 402 provided to the image encoder 404. In some implementations, the image encoder 404 may obtain multiple multichannel images 402 and may generate a single image embedding 406. In other implementations, the image encoder 404 may obtain a single multichannel image 402 and generate a single image embedding 406.

In one implementation, object data 408, region of interest (ROI) data 410, and/or a roadgraph 412 may be provided to a tokenizer 414. The tokenizer 414 may include software (or a subset thereof) configured to obtain data and divide (tokenize) the data into discrete pieces (tokens). The tokenizer 414 may tokenize the object data 408, ROI data 410, and/or roadgraph 412 into one or more tokens 416. Some of the one or more tokens 416 may be based on one or more objects in the driving environment 101 as indicated by the object data 408.

The object data 408 may include data indicating one or more objects in the driving environment 101. An object of the one or more objects may include a mobile object in the driving environment 101 (e.g., a vehicle, a pedestrian, an animal, etc.) or a static object in the driving environment 101 (e.g., a construction cone, road debris, a traffic sign, etc.). The object data 408 may include data about an object of the one or more objects, such as a bounding box of the object, a location of the object in the driving environment 101, an identity of the object (e.g., other vehicle, pedestrian, construction cone, etc.), or other data associated with an object. Different tokens 416 may represent different portions of the object data 408.

In one implementation, an ROI may be associated with the driving environment 101 or the AV 100. An ROI may include a predetermined subset of locations in the driving environment 101. The ROI may include locations that closely relate to the AV's 100 driving. For example, the ROI may exclude a portion of the driving environment 101 that is not accessible to the AV 100 (e.g., a portion of a road separated from the AV 100 by a concrete barrier) or that cannot be sensed by the sensing system 110 of the AV 100. The ROI data 410 may include data indicating the portion of the driving environment 101 within the ROI or data indicating the portion of the driving environment outside of the ROI.

The roadgraph 412 may include data indicating a polyline graph. The polyline graph may include one or more nodes, and each node may indicate a location in the driving environment 101. The polyline graph may include one or more edges, and the edges may indicate accessibility of respective locations in the driving environment 101. For example, an edge from a first node to a second node may indicate that the location represented by the second node is accessible from the location represented by the first node. An edge may be bidirectional or unidirectional. The roadgraph 412 may be stored on the mapping subsystem 130.

In some implementations, the mapping subsystem 130 may include the image encoder 404 and/or the tokenizer 414, and the mapping subsystem 130 may obtain the multichannel image(s) 402, object data 408, ROI data 410, or a roadgraph 412 from other components of the data processing system 120 (e.g., the perception subsystem 124). In other implementations, other components of the data processing system 120 (e.g., the perception subsystem 124) may include the image encoder 404 and/or the tokenizer 414 and may provide the image embedding(s) 406 and/or the tokens 416 to the mapping subsystem 130.

In some implementations, the perception subsystem 124 may generate a set of one or more multichannel images 402, the object data 408, and/or the ROI data 410 that pertain to a certain time and are based on current conditions of the driving environment 101 at that time. For example, at time=0 milliseconds (ms), the perception subsystem 124 may generate a first set of one or more multichannel images 402, object data 408, and/or ROI data 410 based on the current conditions of the driving environment 101 at time 0; at time=125 ms, the perception subsystem 124 may generate a second set of one or more multichannel images 402, object data 408, and/or ROI data 410 based on the current conditions of the driving environment 101 at that time; and at time=250 ms, the perception subsystem 124 may generate a third set of one or more multichannel images 402, object data 408, and/or ROI data 410 based on the current conditions of the driving environment at that time. The process may continue as the AV 100 continues operating.

In one implementation, the mapping subsystem 130 may use one or more image embeddings 406 and/or one or more tokens 416 as input to a transformer encoder 418 to generate an input embedding 420. The transformer encoder 418 may include a portion of a transformer AI model 232A-M configured to generate an input embedding 420 based on one or more image embeddings 406 and/or one or more tokens 416. The input embedding 420 may represent the driving environment 101 in an embedding space based on the one or more image embeddings 406 and one or more tokens 416. The one or more image embeddings 406 and the one or more tokens 416 may correspond to a set of multichannel images 402, object data 408, ROI data 410, and/or a roadgraph 412 that pertain to the same time, as discussed above. Thus, the input embedding 420 may pertain to that same time.

In some implementations, because of the attention mechanism, hidden representations, and other components of the transformer to which the transformer encoder 418 belongs, processing the image embeddings 406 and/or tokens 416 that pertain to a certain time can change how the transformer processes the image embeddings 406 and/or tokens 416 that pertain to one or more subsequent times. This may allow the transformer to persist or “remember” information from one input to one or more subsequent inputs. The ability of the transformer to persist information between inputs increases the accuracy of the transformer.

The input embedding 420 may be provided to a transformer decoder 422 as input. The transformer decoder 422 may use the input embedding 420-along with one or more boundary queries 424 and/or one or more lane queries 426-as input to generate one or more boundary embeddings 428 and/or one or more lane embeddings 430. In some implementations, a boundary query 424 may include a vector that is configured to cause the transformer decoder 422 to output an embedding that provides information about an aspect of the boundaries in the driving environment 101. Similarly, a lane query 426 may include a vector configured to cause the transformer decoder 422 to output an embedding that provides information about an aspect of the lanes in the driving environment 101.

In one implementation, the one or more boundary queries 424 may include multiple boundary queries 424. Each boundary query 424 of the one or more boundary queries 424 may correspond to a certain aspect of the boundaries in the driving environment 101. For example, a first boundary query 424 may correspond to lane markers, a second boundary query 424 may correspond to boundary classifications, and a third boundary query 424 may correspond to boundary curves. Providing a boundary query 424 to the transformer decoder 422, along with the input embedding 420, may cause the transformer decoder 422 to output a boundary embedding 428 that represents the aspect of the boundaries corresponding to the input boundary query 424.

In some implementations, the one or more lane queries 426 may include multiple lane queries 426. Each lane query 426 of the one or more lane queries 426 may correspond to a certain aspect of the lanes in the driving environment 101. For example, a first lane query 426 may correspond to lane classification, a second lane query 426 may correspond to lane attributes, and a third lane query 426 may correspond to lane segment curves. Providing a lane query 426 to the transformer decoder 422, along with the input embedding 420, may cause the transformer decoder 422 to output a lane embedding 430 that represents the aspect of the lanes corresponding to the input lane query 426.

In one implementation, the one or more boundary queries 424 and one or more the lane queries 426 may be generated during a training process of the transformer that includes the transformer encoder 418 and the transformer decoder 422. The training engine 214 may initialize the one or more boundary queries 424 as randomized vectors. The training engine 214 may provide a training input embedding 420 (generated or managed by the training data engine 212) to the transformer decoder 422 during the training process, and the transformer decoder 422 may process the training input embedding 420 along with a boundary query 424, to generate a boundary embedding 428. The generated boundary embedding 428 may be compared to a target boundary embedding 428 that corresponds to the training input embedding 420, and the data of the boundary query 424 and the weights, connections, and other components of the transformer may be adjusted based on the comparison. The training process may continue for other boundary queries 424 and for the one or more lane queries 426 until the training process concludes responsive to instructions from the validation engine 216 and/or testing engine 220.

In one or more implementations, a boundary embedding 428 may include an embedding that represents an aspect of a boundary in the driving environment 101. The aspect may include the aspect that corresponds to the boundary query 424 that was provided as input to the transformer decoder 422 to generate the boundary embedding 428, as discussed above. A lane embedding 430 may include an embedding that represents an aspect of a lane in the driving environment 101. The aspect may include the aspect that corresponds to the lane query 426 that was provided as input to the transformer decoder 422 to generate the lane embedding 430, as discussed above.

FIG. 4B depicts a block diagram of an example data flow 450 for using transformers to generate maps for use by AVs 100, in accordance with some implementations of the present disclosure. The data flow 450 may be a continuation of the data flow 400 of FIG. 4A. In some implementations, the one or more boundary embeddings 428 may be provided as input to one or more boundary-related software components 452-460 of the mapping subsystem 130. The one or more lane embeddings 430 may be provided as input to one or more lane-related software components 464-472 of the mapping subsystem 130. The boundary-related software components 452-460 may include AI models 232A-M or other software configured to generate a boundary output. A boundary output may include information about one or more aspects of the boundaries of the driving environment 101 based on an input boundary embedding 428. The lane-related software components 464-472 may include AI models 232A-M or other software configured to generate a road lane output. A road lane output may include information about one or more aspects of the road lanes of the driving environment 101 based on an input lane embedding 430.

In one implementation, a lane marker classifier 452 may include an AI model 232A-M or other software configured to generate one or more lane marker classifications 454 based on a lane marker-related boundary embedding 428. A lane marker classification 454 may include data classifying a lane marker of the driving environment 101. A classification for a lane marker may indicate whether the lane marker is a solid lane, striped line (and, if so, a length of the stripe), a color of the lane marker, or other lane marker information.

In some implementations, a boundary classifier 456 may include an AI model 232A-M or other software configured to generate one or more boundary classifications 458 based on a boundary-related boundary embedding 428. A boundary classification 458 may include data classifying a boundary of the driving environment 101. A classification for a boundary may indicate the type of boundary. A type of boundary may include what the boundary is made of (e.g., a road curb, a concrete barrier, construction cones or other construction barriers, flares, etc.). A boundary classification 458 may include data indicating a number of boundaries in the driving environment 101. A boundary classification 458 may indicate what is being bounded by the boundary (e.g., a road lane, a construction zone, a sidewalk, or some other area).

In one implementation, a boundary curve decoder 460 may include an AI model 232A-M or other software configured to generate one or more boundary curves 462 based on a boundary curve-related boundary embedding 428. A boundary curve 462 may include data indicating one or more lines or curves that indicate a shape of a boundary in the driving environment 101. A boundary curve 462 may include a polyline that includes one or more connected line segments that represent the shape of a boundary. A boundary curve 462 may include a Bezier curve or another type of curve.

In some implementations, a lane classifier 464 may include an AI model 232A-M or other software configured to generate one or more lane classifications 466 based on a lane classification-related lane embedding 430. A lane classification 466 may indicate a number of lanes of a road in the driving environment 101. A lane classification 466 may indicate an attribute for a lane. An attribute for a lane may indicate whether the lane is open or closed to traffic; a direction of travel for the lane; whether the lane is blocked; whether the lane is controlled by a person, a temporary sign, or device directing traffic; whether the lane is a through lane, turning lane, onramp, offramp, high-occupancy vehicle (HOV) lane, or another type of lane; or other attributes a lane may have. A lane classification 466 may indicate that the lane is part of a construction zone.

In one implementation, a lane curve decoder 468 may include an AI model 232A-M or other software configured to generate one or more lane curves 470 based on a lane curve-related lane embedding 430. A lane curve 470 may include data indicating one or more lines or curves that indicate a shape of a lane in the driving environment 101. A lane curve 470 may include a polyline that includes one or more connected line segments that represent the shape of a lane. A lane curve 470 may include a Bezier curve or another type of curve.

In some implementations, a connectivity predictor 472 may include an AI model 232A-M or other software configured to generate lane connectivity data 474 based on a lane connectivity-related embedding 430. Lane connectivity data 474 may include data indicating whether a first lane is accessible by a second lane in the driving environment 101. The lane connectivity data 474 may include a matrix where each lane is represented by a column and a row of the matrix, and the data in a cell of the matrix indicates whether the lane represented by the row is accessible by the lane represented by the column (or vice versa).

In one implementation, the mapping subsystem 130 may include other AI models 232A-M or other software configured to use one or more boundary embeddings 428 and/or lane embeddings 430 to generate data indicating aspects or features of the driving environment 101. For example, the mapping subsystem 130 may include an object classifier that may include AI model 232A-M or other software configured to generate data classifying objects in the driving environment. The data classifying the objects may include data indicating a location of an object, a size of an object, a type of the object (e.g., vehicle, pedestrian, animal, etc.), a trajectory of an object, or other data associated with an object of the driving environment 101.

In one or more implementations, the lane marker classifications 454, boundary classifications 458, boundary curves 462, lane classifications 466, lane curves 470, and/or lane connectivity data 474 are provided to the mapping subsystem 130. The mapping subsystem 130 may use these pieces of data to generate or update a map of the driving environment 101. The mapping subsystem 130 may provide these pieces of data to the AVCS 140 of the AV 100. The navigation system of the AVCS 140 may use the pieces of data to navigate through the driving environment 101.

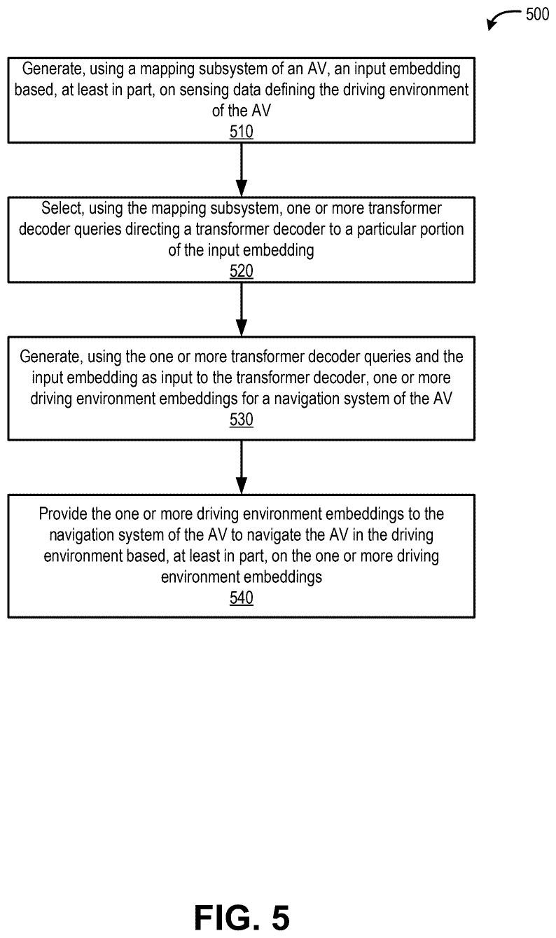

FIG. 5 is a flowchart illustrating one embodiment of a method 500 for using transformers to generate maps for use by AVs 100, in accordance with some implementations of the present disclosure. A processing device, having one or more central processing units (CPU(s)), one or more graphics processing units (GPU(s)), and/or memory devices communicatively coupled to the CPU(s) and/or GPU(s), can perform the method 500 and/or each of their individual functions, routines, subroutines, or operations. The method 500 can be directed to systems and components of a vehicle. In some implementations, the vehicle can be an AV, such as AV 100 of FIG. 1. In some implementations, the vehicle can be a driver-operated vehicle equipped with driver assistance systems, e.g., Level 2 or Level 3 driver assistance systems, that provide limited assistance with specific vehicle systems (e.g., steering, braking, acceleration, etc. systems) or under limited driving conditions (e.g., highway driving). The method 500 can be used to improve performance of the AVCS 140. In certain implementations, a single processing thread can perform the method 500. Alternatively, two or more processing threads can perform the method 500, each thread executing one or more individual functions, routines, subroutines, or operations of the method 500. In an illustrative example, the processing threads implementing the method 500 can be synchronized (e.g., using semaphores, critical sections, and/or other thread synchronization mechanisms). Alternatively, the processing threads implementing the method 500 can be executed asynchronously with respect to each other. Various operations of the method 500 can be performed in a different (e.g., reversed) order compared with the order shown in FIG. 5. Some operations of the method 500 can be performed concurrently with other operations. Some operations can be optional. In one or more implementations, the mapping subsystem 130 may perform one or more operations of the method 500.

At block 510, processing logic generates, using the mapping subsystem 130 of the AV 100, an input embedding 420 based, at least in part, on sensing data. The input embedding 420 can define the driving environment 101 of the AV 100. The sensing data may include the one or more multichannel images 402. In some implementations, the sensing data can include the object data 408, ROI data 410, the roadgraph 412, or the one or more tokens 416, which may have been derived from data obtained from the sensing system 110. Block 510 may include providing the one or more multichannel images 402 as input to an image encoder 404 to generate one or more image embeddings 406, providing the object data 408, ROI data 410, and/or roadgraph 412 as input to a tokenizer 414 to generate one or more tokens 416, and using the one or more image embeddings 406 and/or the one or more tokens 416 as input to a transformer encoder 418 to generate the input embedding 420, as discussed above in relation to the data flow 400.

At block 520, processing logic selects, using the mapping subsystem 130, one or more transformer decoder queries directing a transformer decoder 422 to a particular portion of the input embedding 420. The one or more transformer decoder queries may include the one or more boundary queries 424 and/or the one or more lane queries 426.

At block 530, processing logic generates, using the one or more transformer decoder queries and the input embedding 420 as input to the transformer decoder 422, one or more driving environment embeddings for the navigations system of the AV 100, as discussed above in relation to the data flow 400. Each driving environment embedding may include a vector representation of a feature of the driving environment 101. A driving environment embedding may include a boundary query 424 or a lane query 426 of the data flow 400.

At block 540, processing logic provides the one or more driving environment embeddings to the navigation system of the AV 100. The navigation system may be configured to navigate the AV 100 in the driving environment 101 based, at least in part, on the one or more driving environment embeddings. Navigating the driving environment 101 based, at least in part on the one or more driving environment embeddings may include navigating based on, at least in part, on the lane marker classifications 454, the boundary classifications 458, or the boundary curves 462, which were derived from the one or more driving environment embeddings, as discussed above in relation to the data flow 450. Similarly, navigating the driving environment 101 based, at least in part on the one or more driving environment embeddings may include navigating based on, at least in part, on the lane classifications 466, lane curves 470, and lane connectivity data 474, which were derived from the one or more driving environment embeddings, as discussed above in relation to the data flow 450.

In one implementation, a first driving environment embedding of the one or more driving environment embeddings may include a boundary embedding 428 that includes a vector representation of a boundary in the driving environment 101. The mapping subsystem 130 may generate, using an AI model 232A-M and using the boundary embedding 428 as input to the AI model 232A-M, a boundary output. The boundary output may include a lane marker classification 454, a boundary classification 458, or a boundary curve 462, as discussed above in relation to the data flow 450. A second driving environment embedding of the one or more driving environment embeddings may include a lane embedding 430 that includes a vector representation of a road lane in the driving environment 101. The mapping subsystem may generate, using an AI model 232A-M and using the lane embedding 430 as input to the AI model 232A-M, a road lane output. The road lane output may include a lane classification 466, a lane curve 470, or lane connectivity data 474, as discussed above in relation to the data flow 450. In some implementations, providing the one or more driving environment embeddings to the navigation system of the AV 100 may include providing a lane marker classification 454, a boundary classification 458, a boundary curve 462, a lane classification 466, a lane curve 470, and/or lane connectivity data 474 to the navigation system of the AV 100.

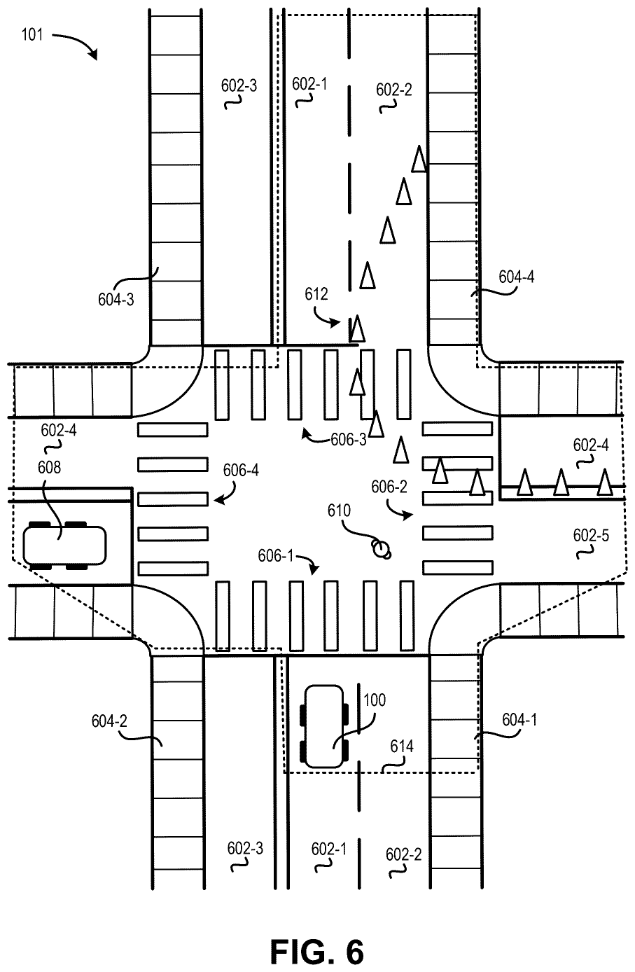

FIG. 6 depicts a top-down view of an example driving environment 101, in accordance with some implementations of the present disclosure. The driving environment 101 may include an AV 100. The driving environment 101 may include one or more road lanes 602-1, . . . , 602-5. The driving environment 101 may include one or more sidewalks 604-1, . . . , 604-4. The driving environment 101 may include one or more crosswalks 606-1, . . . , 606-4. The driving environment 101 may include a vehicle 608. The driving environment 101 may include a traffic controller 610. The driving environment 101 may include one or more construction cones 612. The driving environment 101 may include an ROI 614.

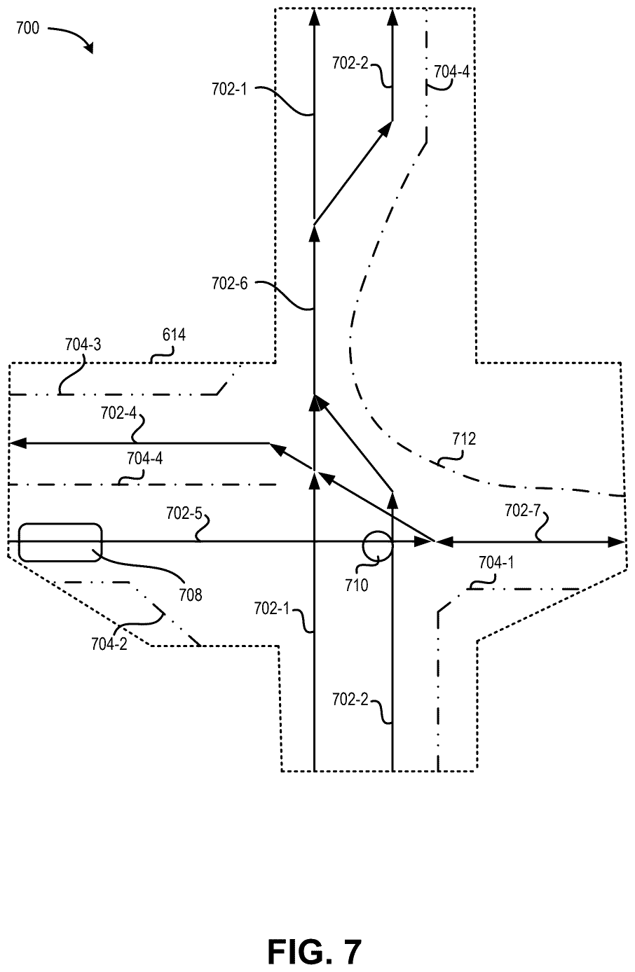

FIG. 7 depicts a schematic diagram of a representation 700 of the driving environment 101 of FIG. 6, in accordance with some implementations of the present disclosure. The representation 700 may include a visual representation based on lane marker classifications 454, boundary classifications 458, boundary curves 462, lane classifications 466, lane curves 470, and/or lane connectivity data 474 (which were derived from the boundary embeddings 428 and/or the lane embeddings 430 generated from the current conditions of the driving environment 101 of FIG. 6).

The representation 700 may include data indicating the existence of a first lane 702-1, which may correspond to the road lane 602-1 in FIG. 6. The first lane 702-1 may indicate the location of the road lane 602-1 and a direction of travel for the road lane 602-1. The representation 700 may include data indicating the existence of a second lane 702-2, which may correspond to the road lane 602-2. The second lane 702-2 may also indicate the location of the road lane 602-1 and a direction of travel. The representation 700 may include data indicating the existence of other lanes 702-4 and 702-5 that correspond to the road lanes 602-4 and 602-5.

Because the road lane 602-3 is located outside of the ROI 614, the representation 700 may not include data indicating a lane corresponding to the road lane 602-3.

The representation 700 may include data indicating a lane 702-6, which may correspond to a location where the lanes 702-1 and 702-2 converge (because part of the road lane 602-2 is blocked by the construction cones 612). Similarly, the representation 700 may include data indicating a lane 702-7, which may correspond to a location where the lanes 702-4 and 702-5 converge (because part of the road lane 602-4 is blocked by the construction cones 612). The lanes 702-6 and 702-6 may indicate the locations of the corresponding road lanes 602-2 and 602-4 and their respective directions of travel. The data indicating the lanes 702-5 and 702-7 may indicate that these lanes are controlled by the traffic controller 610, represented by the object 710. The data indicating the lanes 702-1, . . . , 702-7 may be based on one or more lane classifications 466, lane curves 470, or lane connectivity data 474.

The representation 700 may include data indicating one or more boundaries 704-1, . . . , 704-3 that correspond to the curbs of the sidewalks 604-1, . . . , 604-3, respectively. The data indicating the one or more boundaries 704-1, . . . , 704-3 may indicate the locations of the boundaries, a type of boundary (sidewalk curb), and other boundary information. The representation 700 may include data indicating a boundary 704-1 that corresponds to a lane marker between the lanes 602-4 and 602-5. The data indicating the boundary 704-4 may indicate the location of the boundary, the type of boundary (solid yellow line lane marker), or other boundary information. The data indicating the boundaries 704-1, . . . , 704-4 may be based on one or more lane marker classifications 454, boundary classifications 458, or boundary curves 462.

The representation 700 may include data indicating the vehicle 708, which may correspond to the vehicle 608. The data indicating the vehicle 708 may include data indicating a location or size of the vehicle 608. The representation 700 may include data indicating a boundary 712 that corresponds to the construction cones 612. The data indicating the boundary 712 may include a boundary curve, a type of boundary (construction cones), and other boundary information. The data indicating the boundary 712 may be based on one or more lane boundary classifications 458 or boundary curves 462.

In some implementations, the mapping subsystem 130 may provide the data represented by the representation 700 to the AVCS 140 of the AV 100. The navigation system of the AVCS 140 may navigate the AV 100 through the driving environment 101. The mapping subsystem 130 may use the data represented by the representation 700 to generate or update a map corresponding to the driving environment 101.

In some implementations, the mapping subsystem 130 may be located on a server that is external from the AV 100. The server and the AV 100 may be in data communication over a data network (e.g., a cellular network). The AV 100 may send data generated by the perception subsystem 124 to the mapping subsystem 130 on the server over the data network, the mapping subsystem 130 may perform one or more operations discussed herein to generate the boundary embeddings 428 and/or the lane embeddings 430, and the server may send the boundary embeddings 428 and/or the lane embeddings 430 to the AV 100 for use by the AVCS 140 to navigate the AV 100 in the driving environment 101.

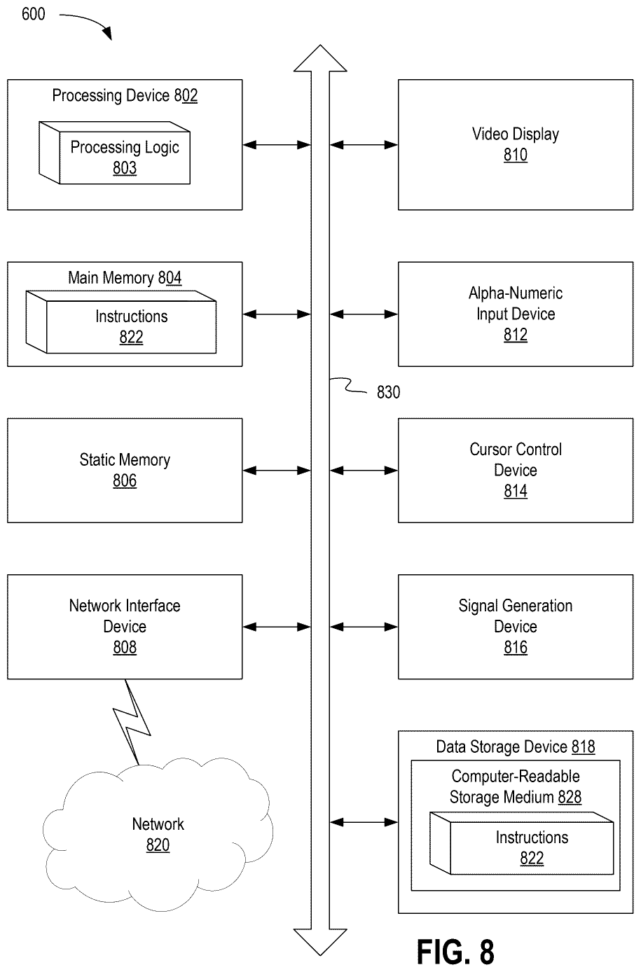

FIG. 8 depicts a block diagram of an example computer device 800 capable of using transformers to generate maps for use by AVs 100, in accordance with some implementations of the present disclosure. Example computer device 800 can be connected to other computer devices in a local area network (LAN), an intranet, an extranet, and/or the Internet. The computer device 800 can operate in the capacity of a server in a client-server network environment. The computer device 800 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

The example computer device 800 can include a processing device 802 (also referred to as a processor or CPU), a main memory 804 (e.g., read-only memory (ROM), flash memory, dynamic random access memory (DRAM) such as synchronous DRAM (SDRAM), etc.), a static memory 806 (e.g., flash memory, static random access memory (SRAM), etc.), and a secondary memory (e.g., a data storage device 818), which can communicate with each other via a bus 830.

The processing device 802 (which can include processing logic 803) represents one or more general-purpose processing devices such as a microprocessor, CPU, or the like. More particularly, the processing device 802 can be a complex instruction set computing (CISC) microprocessor, reduced instruction set computing (RISC) microprocessor, very long instruction word (VLIW) microprocessor, processor implementing other instruction sets, or processors implementing a combination of instruction sets. The processing device 802 can also be one or more special-purpose processing devices such as a GPU, an application specific integrated circuit (ASIC), a field programmable gate array (FPGA), a digital signal processor (DSP), network processor, or the like. In accordance with one or more aspects of the present disclosure, the processing device 802 can be configured to execute instructions performing the method 500 for using transformers to generate maps for use by AVs 100.

The example computer device 800 can further comprise a network interface device 808, which can be communicatively coupled to a network 820. A network interface device 808 may include a network card, a network interface controller, or some other network interface. The network 820 may include a LAN, an intranet, an extranet, the Internet, a modem, a router, a switch, or some other network or network device. In some embodiments, the computer device 800 may be in data communication with other systems or devices over the network 820. Example computer device 800 can further comprise a video display 810 (e.g., a liquid crystal display (LCD), a touch screen, or a cathode ray tube (CRT)), an alphanumeric input device 812 (e.g., a keyboard), a cursor control device 814 (e.g., a mouse), and an acoustic signal generation device 816 (e.g., a speaker).

The data storage device 818 can include a computer-readable storage medium 828 (or, more specifically, a non-transitory computer-readable storage medium) on which is stored one or more sets of executable instructions 822. In accordance with one or more aspects of the present disclosure, executable instructions 822 can comprise executable instructions performing the method 500.

Executable instructions 822 can also reside, completely or at least partially, within the main memory 804 and/or within the processing device 802 during execution thereof by the example computer device 800, the main memory 804, and/or the processing device 802 also constituting computer-readable storage media. Executable instructions 822 can further be transmitted or received over a network via the network interface device 808.

While the computer-readable storage medium 828 is shown in FIG. 8 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

In some cases, certain components of the AV 100 (e.g., the sensing system 110, the data processing system 120, the AVCS 140, or other components) may include a computer device 800.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method, comprising:
generating, using a mapping subsystem of an autonomous vehicle (AV), an input embedding based, at least in part, on sensing data from a sensing system of the AV, wherein the input embedding defines a driving environment of the AV;
selecting, using the mapping subsystem, one or more transformer decoder queries directing a transformer decoder to a particular portion of the input embedding;
generating, using the one or more transformer decoder queries and the input embedding as input to the transformer decoder, one or more driving environment embeddings for a navigation system of the AV, wherein each driving environment embedding comprises a vector representation of a feature of the driving environment; and
providing the one or more driving environment embeddings to the navigation system of the AV, wherein the navigation system is configured to navigate the AV in the driving environment based, at least in part, on the one or more driving environment embeddings.

2. The method of claim 1, wherein the sensing data comprises a multichannel image of the driving environment.

3. The method of claim 2, wherein the multichannel image of the driving environment comprises a heatmap indicating a plurality of locations in the driving environment and, for each location in the plurality of locations, a probability of a presence of an object at the respective location.

4. The method of claim 2, further comprising:
generating an image embedding based on the multichannel image of the driving environment; and
using the image embedding as input to a transformer encoder to generate the input embedding.

5. The method of claim 1, wherein a first driving environment embedding of the one or more driving environment embeddings comprises a boundary embedding comprising a vector representation of a boundary in the driving environment.

6. The method of claim 5, wherein:
the method further comprises generating, using an artificial intelligence (AI) model and using the boundary embedding as input to the AI model, a boundary output, wherein the boundary output comprises at least one of:
a lane marker classification,
a boundary classification, or
a boundary curve; and
providing the one or more driving environment embeddings to the navigation system of the AV comprises providing the boundary output to the navigation system of the AV.

7. The method of claim 1, wherein a second driving environment embedding of the one or more driving environment embeddings comprises a lane embedding comprising a vector representation of a road lane in the driving environment.

8. The method of claim 7, wherein:
the method further comprises generating, using an AI model and using the second driving environment embedding as input to the AI model, a road lane output, wherein the road lane output comprises at least one of:
a lane classification,
a lane curve, or
lane connectivity data; and
providing the one or more driving environment embeddings to the navigation system of the AV comprises providing the road lane output to the navigation system of the AV.

9. A system, comprising:
a mapping subsystem of an autonomous vehicle (AV) configured to:
generate an input embedding based, at least in part, on sensing data from a sensing system of the AV, wherein the input embedding defines a driving environment of the AV,
select one or more transformer decoder queries directing a transformer decoder to a particular portion of the input embedding,
generate, using the one or more transformer decoder queries and the input embedding as input to the transformer decoder, one or more driving environment embeddings for a navigation system of the AV, wherein each driving environment embedding comprises a vector representation of a feature of the driving environment, and
provide the one or more driving environment embeddings to the navigation system of the AV, wherein the navigation system is configured to navigate the AV in the driving environment based, at least in part, on the one or more driving environment embeddings.

10. The system of claim 9, wherein the input embedding is based, at least in part, on one or more tokens based on one or more objects in the driving environment.

11. The system of claim 10, wherein an object of the one or more objects comprises at least one:
a mobile object in the driving environment; or
a static object in the driving environment.

12. The system of claim 9, wherein the input embedding is based, at least in part, on one or more tokens based on a region of interest in the driving environment, wherein the region of interest comprises a predetermined subset of locations in the driving environment.

13. The system of claim 9, wherein the input embedding is based, at least in part, on a roadgraph corresponding to the driving environment, wherein the roadgraph comprises data indicating a polyline graph comprising one or more nodes each indicating a location in the driving environment and one or more edges indicating accessibility of respective the locations.

14. The system of claim 9, wherein the sensing data comprises a multichannel image of the driving environment.

15. The system of claim 9, wherein a first driving environment embedding of the one or more driving environment embeddings comprises a boundary embedding comprising a vector representation of a boundary in the driving environment.

16. A method, comprising:
generating, using a mapping subsystem of an autonomous vehicle (AV), an input embedding based, at least in part, on sensing data from a sensing system of the AV, wherein the input embedding defines a driving environment of the AV;
selecting, using the mapping subsystem, one or more transformer decoder queries directing a transformer decoder to a particular portion of the input embedding;
generating, using the one or more transformer decoder queries and the input embedding as input to the transformer decoder, one or more driving environment embeddings, wherein each driving environment embedding comprises a vector representation of a feature of the driving environment;
generating, using a first artificial intelligence (AI) model and using a first driving environment embedding of the one or more driving environment embeddings, a boundary output, wherein the boundary output comprises data indicating a feature of a boundary of the driving environment; and
providing the boundary output to a navigation system of the AV, wherein the navigation system is configured to navigate the AV in the driving environment based, at least in part, on the boundary output.

17. The method of claim 16, wherein the boundary output comprises at least one of:
a lane marker classification;
a boundary classification; or
a boundary curve.

18. The method of claim 16, further comprising generating, using a second AI model and using a second driving environment embedding of the one or more driving environment embeddings, a road lane output, wherein the road lane output comprises data indicating a feature of a road lane of the driving environment.

19. The method of claim 18, wherein the road lane output comprises at least one of:
a lane classification;
a lane curve; or
lane connectivity data.

20. The method of claim 18, further comprising providing the road lane output to the navigation system of the AV, wherein the navigation system is further configured to navigate the AV in the driving environment based, at least in part, on the road lane output.
